(19) United States
(12) Patent Application Publication
(10) Pub. No.: US 2008/0309976 A1
(43) Pub. Date: Dec. 18, 2008

(54) Communication device

(75) Inventor: Hideki Inoishi, Tokyo (JP)

Correspondence Address: KUBOTERA & ASSOCIATES, LLC, SUITE 202, 200 DAINGERFIELD ROAD, ALEXANDRIA, VA, 22314, US

(73) Assignee: Oki Data Corporation

(21) Appl. No.: 12/155,529

(22) Filed: Jun. 5, 2008

(30) Foreign Application Priority Data
Jun. 15, 2007 (JP) 2007-158114

(51) Int. Cl. G06F 3/12

(52) U.S. Cl. 358/1.15

(57) ABSTRACT

A communication device includes an input unit for inputting first image data and additional information; a multi-dimensional code creation unit for creating a multi-dimensional code according to the additional information; a combination unit for combining the multi-dimensional code with the first image data to create second image data; and a transmission unit for sending the second image data.

### BACKGROUND OF THE INVENTION AND RELATED ART STATEMENT

The present invention relates to a communication device.

In a conventional facsimile, when an image of an original is sent to a destination, origination information registered in advance is converted to a text string and combined with an input image before being sent. The origination information includes telephone number information, originator information, page number information, and the likes (refer to Patent Reference).

Patent Reference: Japanese Patent Publication No. 05-48790

In the conventional facsimile, the origination information is converted to the text string and combined with the input image. Accordingly, a printing sheet has a limited space, and it is difficult to combine the origination information having a large amount. As a result, it is possible to send the origination information having only telephone number information, originator information, page number information, and the likes to the destination. It is difficult to send the origination information having a large amount.

In view of the problems described above, an object of the present invention is to provide a communication device capable of solving the problems of the conventional communication device. In the communication device of the present invention, additional information stored in a data storage unit is retrieved to create a multi-dimensional code, and the multi-dimensional code is combined with image data before being sent. Accordingly, it is possible to provide the communication device with high information transmission capability and capable of sending information having a large amount.

Further objects and advantages of the invention will be apparent from the following description of the invention.

### SUMMARY OF THE INVENTION

In order to attain the objects described above, according to the present invention, a communication device includes an input unit for inputting first image data and additional information; a multi-dimensional code creation unit for creating a multi-dimensional code according to the additional information; a combination unit for combining the multi-dimensional code with the first image data to create second image data; and a transmission unit for sending the second image data.

In the communication device of the present invention, the additional information stored in a data storage unit is retrieved to create the multi-dimensional code, and the multi-dimensional code is combined with the image data before being sent. Accordingly, it is possible to significantly improve information transmission capability and send information having a large amount.

### BRIEF DESCRIPTION OF THE DRAWINGS

FIG. 1 is a schematic block diagram showing a configuration of a communication device according to a first embodiment of the present invention;

FIG. 2 is a schematic view showing an operational panel according to the first embodiment of the present invention;

FIG. 3 is a schematic view showing a configuration of an ROM (Read Only Memory) according to the first embodiment of the present invention;

FIG. 4 is a schematic view showing a configuration of an RAM (Random Access Memory) according to the first embodiment of the present invention;

FIG. 5 is a schematic view showing a relationship between an image and an image data storage unit according to the first embodiment of the present invention;

FIG. 6 is a schematic view showing a configuration of an image data processing section according to the first embodiment of the present invention;

FIG. 7 is a schematic view showing a combining order of image data according to the first embodiment of the present invention;

FIG. 8 is a flow chart showing an operation of the image data processing section according to the first embodiment of the present invention;

FIG. 9 is a schematic view showing an example No. 1 of a transmitted image without a QR (Quick Response) code according to the first embodiment of the present invention;

FIG. 10 is a schematic view showing an example No. 2 of the transmitted image with the QR code according to the first embodiment of the present invention;

FIG. 11 is a flow chart showing an operation of the communication device according to the first embodiment of the present invention;

FIGS. 12(a) and 12(b) are schematic views showing transmitted images according to a second embodiment of the present invention, wherein FIG. 12(a) is a view showing the transmitted image without a skipping process, and FIG. 12(b) is a view showing the transmitted image with the skipping process; and

FIG. 13 is a flow chart showing an operation of an image data processing section according to the second embodiment of the present invention.

### DETAILED DESCRIPTION OF PREFERRED EMBODIMENTS

Hereunder, embodiments of the present invention will be explained with reference to the accompanying drawings.

### First Embodiment

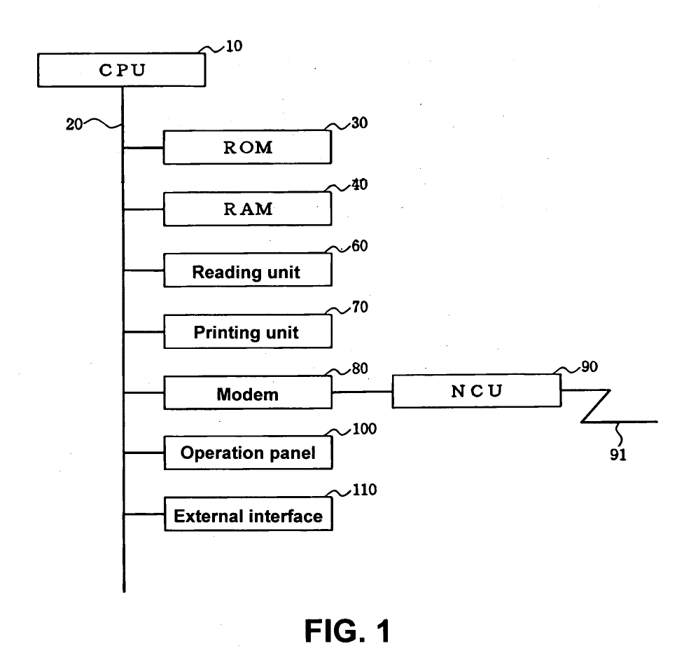

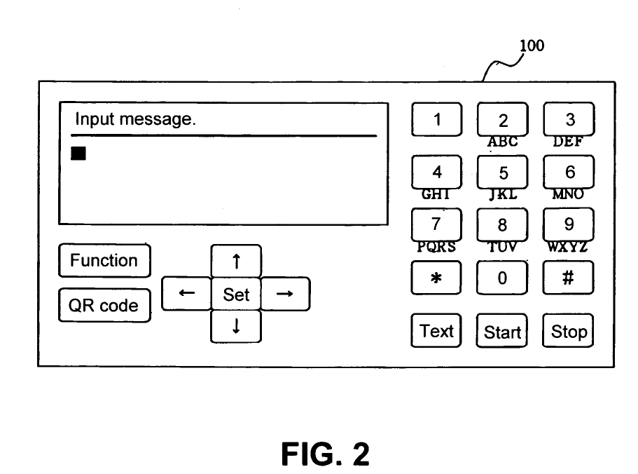

A first embodiment of the present invention will be explained. FIG. 1 is a schematic block diagram showing a configuration of a communication device according to the first embodiment of the present invention. FIG. 2 is a schematic view showing an operational panel 100 according to the first embodiment of the present invention.

In the embodiment, the communication device is a device capable of transmitting an input image, and may be a device such as a facsimile, a copier, a printer, and the likes. In the following description, the communication device is a facsimile.

As shown in FIG. 1, the communication device includes a CPU (Central Processing Unit) 10 as a calculation unit for controlling an operation of the facsimile; and an ROM (Read Only Memory) 30 as a storage unit for storing a program or software executed by the CPU 10.

Further, the communication device includes an RAM (Random Access Memory) 40 as a storage unit for storing data generated upon executing the program with the CPU 10. As described later, the RAM 40 has a plurality of data storage units. The communication device also includes a reading unit 60. The reading unit 60 is a scanner device using a reading sensor such as an LED (Light Emitting Diode) and a CCD (Charge Coupled Device) for reading an original and converting to dot image data.

Further, the communication device includes a printing unit 70. The printing unit 70 is a printer device of a thermal recording type, an electric-photography type, and the likes for outputting image data read with the reading unit 60 or image data received through facsimile communication as a hard copy.

In the embodiment, the communication device includes a modem 80. The modem 80 is a modulation-demodulation device for modulating and demodulating order data and image data through a facsimile communication control order, and for exchanging data with a mating facsimile.

In the embodiment, the communication device includes an NCU (network Control Unit) 90. The NCU 90 is a network control device for controlling connection and disconnection between the modem 80 and a network 91. The network 91 includes a switched line network such as a public telephone network, a local telephone network, and the likes.

In the embodiment, the communication device includes the operation panel 100. As shown in FIG. 2, the operational panel 100 has a key input portion and a display portion. The key portion has a function key, cursor keys, a start key, a QR (Quick Response) code key, and the likes necessary for an operator to operate the facsimile. The display portion displays a status of the facsimile on a display device such as an LCD (Liquid Crystal Display) and a CRT display.

In the embodiment, the communication device includes an external interface 110. The external interface 110 has an USB (Universal Serial Bus) interface and a network interface for communicating with an external device (not shown).

In the embodiment, the CPU 10, the ROM 30, the RAM 40, the reading unit 60, the printing unit 70, the modem 80, the NCU 90, the operational panel 100, and the external interface 110 are connected through a system bus 20, so that they can mutually communicate for controlling hardware and executing software.

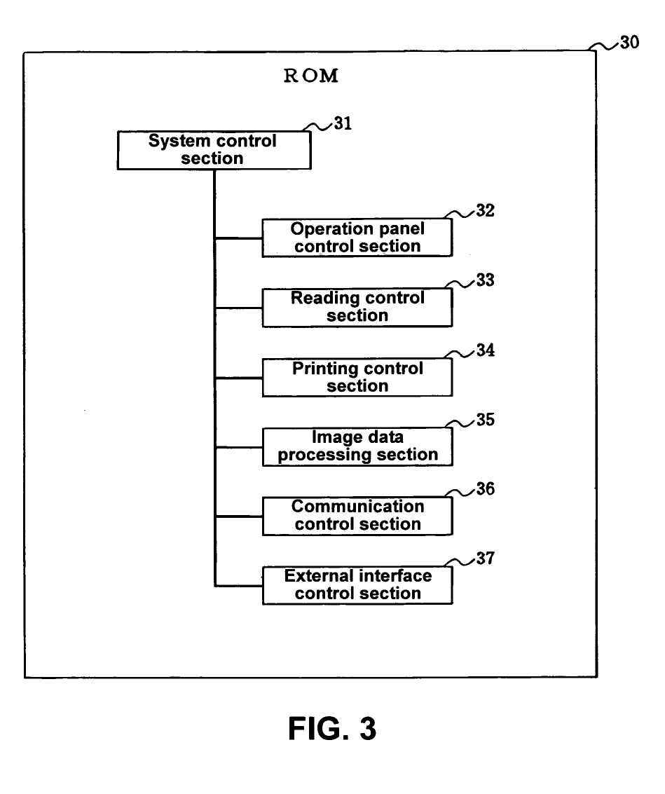

A configuration of the ROM 30 will be explained next. FIG. 3 is a schematic view showing the configuration of the ROM (Read Only Memory) 30 according to the first embodiment of the present invention.

As shown in FIG. 3, the ROM 30 includes a system control section 31; an operation panel control section 32; a reading control section 33; a printing control section 34; an image data processing section 35; a communication control section 36; and an external interface control section 37.

In the embodiment, the system control section 31 administers each resource in the system, and starts and adjusts a control program. The operation panel control section 32 controls the operational panel 100, and executes a user interface. The reading control section 33 controls the reading unit 60, and executes a series of operations related to reading of an original. The printing control section 34 controls the printing unit 70, and executes a series of operations related to printing.

In the embodiment, the image data processing section 35 edits a transmitted image, and generates FAX encoding data. The communication control section 36 controls the modem 80 and the NCU 90 to connect to a public telephone network, and executes the facsimile transmission control order and reception of image data. The external interface control section 37 controls the external interface 110, and executes connection to the external device and reception of data.

In the embodiment, the operation panel control section 32 controls the operational panel 100, thereby making it possible to input a telephone number, register various data, input a message, and the likes.

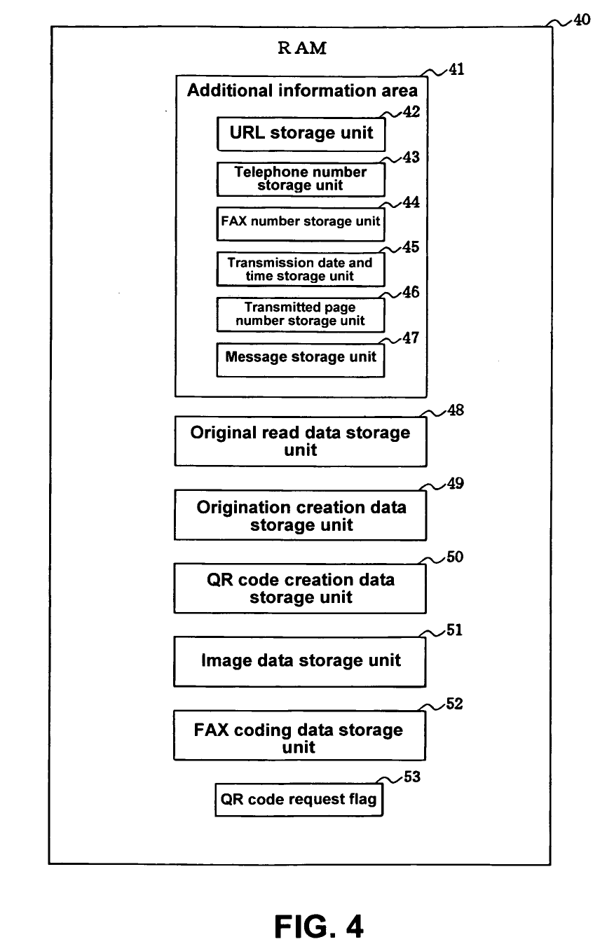

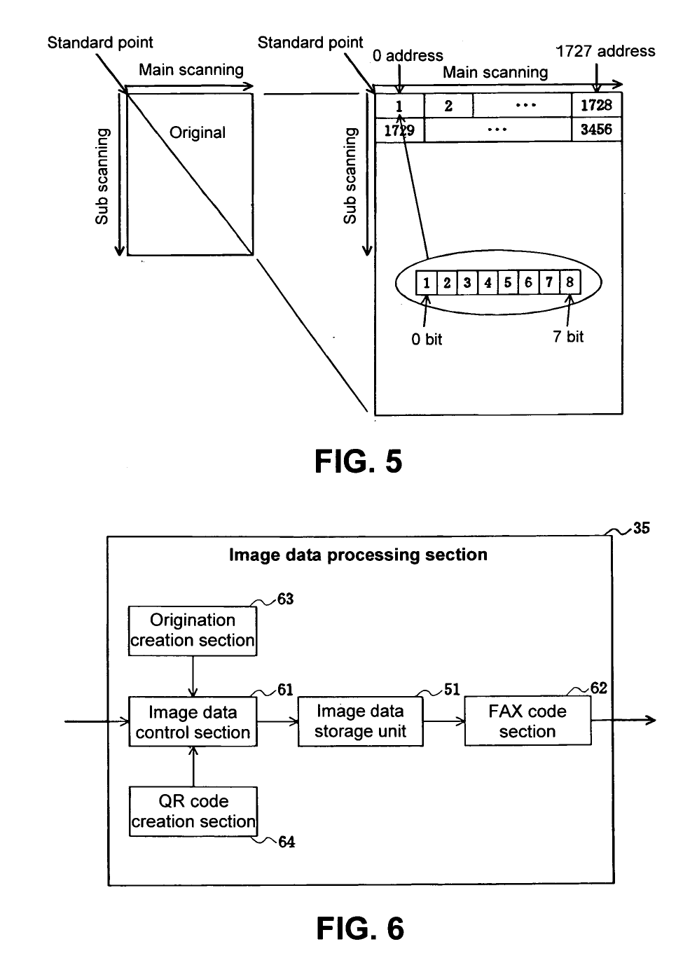

A configuration of the RAM 40 will be explained next. FIG. 4 is a schematic view showing the configuration of the RAM 40 according to the first embodiment of the present invention. FIG. 5 is a schematic view showing a relationship between an image and an image data storage unit according to the first embodiment of the present invention.

As shown in FIG. 4, the RAM 40 includes an additional information area 41 as a data storage unit having a plurality of data (described later), and stores origination information as additional information to be added to a transmitted image. The additional information area 41 includes a URL (Uniform Resource Locator) storage unit 42; a telephone number storage unit 43; a FAX number storage unit 44; a transmission date and time storage unit 45; a transmitted page number storage unit 46; and a message storage unit 47.

In the embodiment, the URL storage unit 42 stores URL data such as a home page address of an origination company input by an operator through the operation panel control section 32. The telephone number storage unit 43 stores telephone number data such as a telephone number of the origination company input by the operator through the operation panel control section 32. The FAX number storage unit 44 stores FAX number data such as a FAX number of the origination company input by the operator through the operation panel control section 32.

In the embodiment, the transmission date and time storage unit 45 stores date and time data when the operator starts the facsimile transmission through the operation panel control section 32. The transmitted page number storage unit 46 stores page number data read with the reading control section 33. The message storage unit 47 stores message data input by the operator through the operation panel control section 32.

In the embodiment, the RAM 40 further includes an original read data storage unit 48; an origination creation data storage unit 49; a QR code creation data storage unit 50; an image data storage unit 51; a FAX coding data storage unit 52; and a QR code request flag 53.

In the embodiment, the original read data storage unit 48 stores dot image data read with the reading control section 33. The origination creation data storage unit 49 stores dot image data created according to information stored in the additional information area 41 with the system control section 31. The QR code creation data storage unit 50 stores dot image data created according to information stored in the message storage unit 47 with the image data processing section 35. The image data storage unit 51 stores dot image data created with the image data processing section 35.

As shown in FIG. 5, the image data storage unit 51 stores the dot image data having an upper left of an original as a standard point. The standard point of the original corresponds to an address of zero in the image data storage unit 51. One line corresponds to data through scanning the original from a left side to a right side, i.e., main scanning. When an original having the A-4 size is scanned at a standard resolution (8 dots/mm), data of one line becomes 1728 bytes. In this case, one byte corresponds to 8 dots.

An end point of one line corresponds to an address of 1727 in the image data storage unit 51. A subsequent line corresponds to data through scanning the original from an upper side to a lower side, i.e., sub scanning. When an original having the A-4 size is scanned at a standard resolution (3.85 lines/mm), a total number becomes about 1143 lines (3.85 lines×297 mm). Accordingly, when an original having the A-4 size is scanned at the standard resolution, a total size of the data becomes 1728 bytes×1143 lines=about 1928 K bytes.

In the embodiment, the FAX coding data storage unit 52 stores code data coded with the image data processing section 35 from the dot image data stored in the image data storage unit 51. The QR code request flag 53 indicates whether the operator sets addition of a QR code through the operation panel control section 32. That is, when the QR code request flag 53 is ON, the QR code is requested to add. When the QR code request flag 53 is OFF, the QR code is not requested to add.

A configuration of the image data processing section 35 will be explained next. FIG. 6 is a schematic view showing the configuration of the image data processing section 35 according to the first embodiment of the present invention.

In the embodiment, the image data processing section 35 adds the origination information and the QR code as the dot image data to be stored in the image data storage unit 51 according to the dot image data stored in the original read data storage unit 48. Further, the image data processing section 35 stores data coded to a FAX code according to the dot image data stored in the image data storage unit 51 into the FAX coding data storage unit 52.

In the embodiment, an image data control section 61 executes and controls the following operations. First, the image data control section 61 retrieves the dot image data stored in the original read data storage unit 48, and writes the dot image data in the image data storage unit 51. Second, the image data control section 61 starts an origination creation section 63. Then, the image data control section 61 retrieves the dot image data stored in the origination creation data storage unit 49, and writes the dot image data in the image data storage unit 51.

Third, the image data control section 61 starts a QR code creation section 64. Then, the image data control section 61 retrieves the dot image data stored in the QR code creation data storage unit 50, and writes the dot image data in the image data storage unit 51. Fourth, the image data control section 61 starts a FAX code section 62. Then, the image data control section 61 retrieves the dot image data stored in the image data storage unit 51, and writes the FAX coding data in the FAX coding data storage unit 52.

In the embodiment, the image data control section 61 starts the origination creation section 63. Further, the origination creation section 63 converts data stored in the transmission date and time storage unit 45, the FAX number storage unit 44, and the transmitted page number storage unit 46 to the dot image data, and stores the dot image data in the origination creation data storage unit 49.

Similarly, the image data control section 61 starts the QR code creation section 64, so that the QR code creation section 64 converts data stored in the URL storage unit 42, the telephone number storage unit 43, and the message storage unit 47 to the dot image data after being converted into the QR code, and stores the dot image data in the QR code creation data storage unit 50.

Similarly, the image data control section 61 starts the FAX code section 62, so that the FAX code section 62 converts the dot image data stored in the image data storage unit 51 to the FAX code, and stores the FAX code in the FAX coding data storage unit 52.

An operation of the communication device will be explained next. First, an operation of the image data processing executed with the image data processing section 35 will be explained.

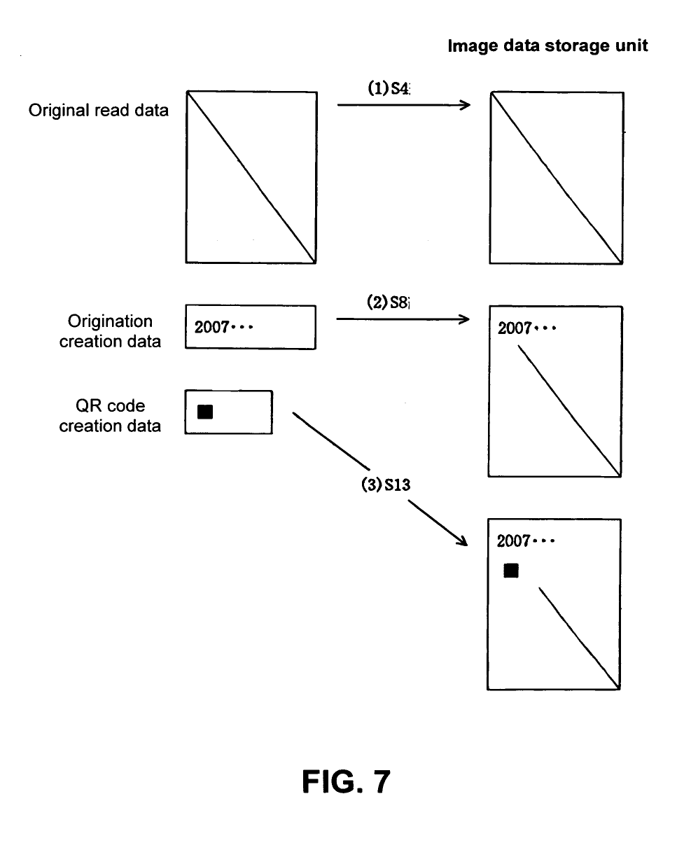

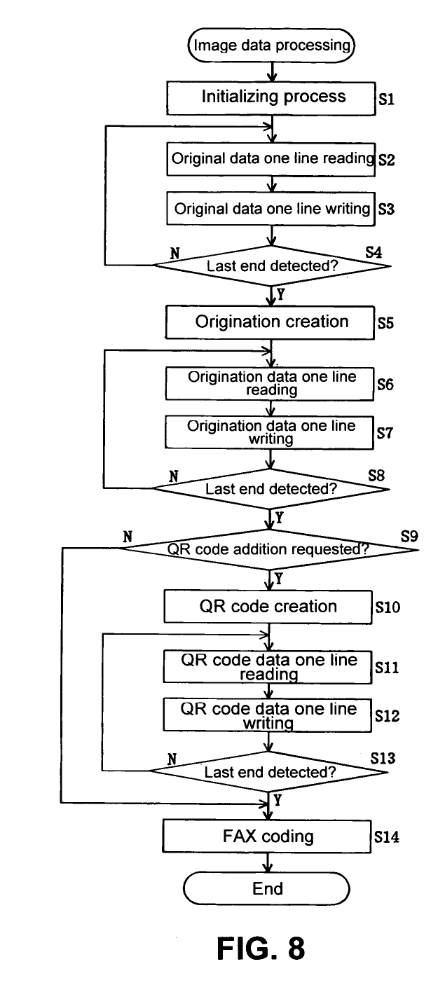

FIG. 7 is a schematic view showing a combining order of the image data according to the first embodiment of the present invention. FIG. 8 is a flow chart showing an operation of the image data processing section 35 according to the first embodiment of the present invention.

In the embodiment, the reading control section 33 starts the image data processing section 35, so that the image data processing section 35 executes the image data processing while reading the original.

First, the image data processing section 35 executes an initializing process. Accordingly, the image data processing section 35 clears control data generated upon executing the image data processing.

In the next step, the image data processing section 35 executes “original data one line reading”, that is, the image data processing section 35 retrieves the dot image data of one line from the original read data storage unit 48. As described above, the dot image data with the upper left of the original as the standard point are stored in the original read data storage unit 48. One line corresponds to data obtained through scanning the original from the left side to the right side. When the original having the A-4 size is scanned at the standard resolution (8 dots/mm), a total size of the data becomes 1728 bytes.

In the next step, the image data processing section 35 executes “original data one line writing”, that is, the image data processing section 35 writes the data of one line obtained through “original data one line reading” to the image data storage unit 51.

In the next step, the image data processing section 35 determines whether a last end is detected to determine a last end of the original. In detecting the last end, a byte number written in the original read data storage unit 48 with the reading control section 33 is compared with a byte number read through the “original data one line reading”.

When a comparison result is not matched, it is determined that the last end is not detected, and the “original data one line reading” is performed one more time. When the comparison result is matched, it is determined that the last end is detected. Accordingly, the dot image data are completely copied from the original read data storage unit 48 to the image data storage unit 51, thereby obtaining a state indicated as (1) in FIG. 7.

In the next step, the image data processing section 35 executes “origination creation” to create the origination information. That is, the image data processing section 35 determines font data from the data stored in the transmission date and time storage unit 45, the FAX number storage unit 44, and the transmitted page number storage unit 46. Then, the image data processing section 35 rasterizes and stores the dot image data in the origination creation data storage unit 49.

In the next step, the image data processing section 35 executes “origination data one line reading”, that is, the image data processing section 35 retrieves the dot image data of one line from the origination creation data storage unit 49. As described above, the dot image data with the upper left of the origination information as the standard point are stored in the origination creation data storage unit 49. One line corresponds to data obtained through scanning the origination information from the left side to the right side. When the original having the A-4 size is scanned at the standard resolution (8 dots/mm), a total size of the data becomes 1728 bytes.

In the next step, the image data processing section 35 executes “origination data one line writing”, that is, the image data processing section 35 writes the data of one line obtained through the “origination data one line reading” to the image data storage unit 51 as an overwriting on the original read data.

In the next step, the image data processing section 35 determines whether a last end is detected to determine a last end of the origination. In detecting the last end, a byte number written in the original read data storage unit 48 upon creating origination is compared with a byte number read through the “origination data one line reading”.

When a comparison result is not matched, it is determined that the last end is not detected, and the “origination data one line reading” is performed one more time. When the comparison result is matched, it is determined that the last end is detected. Accordingly, the dot image data are completely copied from the origination creation data storage unit 49 to the image data storage unit 51, thereby obtaining a state indicated as (2) in FIG. 7.

In the next step, the image data processing section 35 performs a QR request determination, and determines whether the QR code is added with the QR code request flag 53. As described above, the QR code request flag 53 indicates whether the operator requests to add the QR code through the operation panel control section 32.

When the QR code request flag 53 is OFF, it is determined that the QR code is not added, and the image data processing section 35 executes “FAX coding”. When the QR code request flag 53 is ON, it is determined that the QR code is added, and the image data processing section 35 executes “QR code creation” for creating the QR code. In creating the QR code, after being converted to the QR code, the image data processing section 35 rasterizes the data stored in the URL storage unit 42, the telephone number storage unit 43, and the message storage unit 47 according to ISO/IEC18004 standard, and stores the dot image data in the QR code creation data storage unit 50.

At this time, a byte number of one line is temporarily stored in a temporary storage area. Note that it is necessary to set various parameters for creating the QR code. Accordingly, it may be arranged such that various parameters related to the QR code can be set, for example, when the operation pushes the QR code key.

In the next step, the image data processing section 35 executes “QR code data one line reading”, so that the image data processing section 35 retrieves the dot image data of one line from the QR code creation data storage unit 50. As described above, the dot image data with the upper left of the QR code as the standard point are stored in the QR code creation data storage unit 50. One line corresponds to data obtained through scanning the QR code from the left side to the right side, and has a byte number corresponding to an information amount contained in the QR code. Then, the byte number of one line is retrieved from the temporarily storage area, thereby stopping retrieving.

In the next step, the image data processing section 35 executes “QR code data one line writing”, so that the image data processing section 35 writes the data of one line read through the “QR code data one line reading” into the image data storage unit 51 as an overwriting on the original read data. Accordingly, the data are written into the image data storage unit 51 after the origination information.

In the next step, the image data processing section 35 determines whether a last end is detected to determine a last end of the QR code. In detecting the last end, a number re-read to a bit number from the byte number of one line in the temporary storage area is compared with a number of reading in the “QR code data one line reading”. For example, when the byte number of one line is 10, the bit number is 80, and the number re-read becomes 80.

When a comparison result is not appropriate, that is, the number of reading in the “QR code data one line reading” is not a number capable of being converted to a number corresponding to a same length in the main scanning direction, it is determined that the last end is not detected, that is, the last end of the QR code is not detected. Accordingly, the “QR code data one line reading” is performed one more time.

When the comparison result is appropriate, that is, the number of reading in the “QR code data one line reading” is a number capable of being converted to a number corresponding to a same length in the main scanning direction, it is determined that the last end is detected, that is, the last end of the QR code is detected. This means that the dot image data are completely copied from the QR code creation data storage unit 50 to the image data storage unit 51, and the image data storage unit 51 becomes a state indicated as (3) in FIG. 7.

In the next step, the image data processing section 35 executes the “FAX coding”, thereby completing the image data processing. In the “FAX coding”, the image data processing section 35 codes into a FAX code according to the dot image data stored in the image data storage unit 51, and stores the FAX code into the FAX coding data storage unit 52. More specifically, the image data processing section 35 codes the dot image data stored in the image data storage unit 51 to the FAX code according to the ITU-T.4/T.6 standard, and stores that FAX code into the FAX coding data storage unit 52.

In the example shown in FIG. 7, only one original is shown because of convenience for the explanation, and the original may be plural. When images on a plurality of originals are transmitted, message data input by the operator are divided into a number of the originals of the images to be transmitted, and the QR codes of the image data divided into each transmitted page may be combined.

The flow chart shown in FIG. 8 will be explained next. In step S1, the initializing process is performed. In step S2, the original data one line reading is performed. In step S3, the original data one line writing is performed. In step S4, it is determined whether the last end is detected. When the last end is detected, the process proceeds to step S5. When the last end is not detected, the process returns to step S2.

In step S5, the origination creation is performed. In step S6, the origination data one line reading is performed. In step S7, the origination data one line writing is performed. In step S8, it is determined whether the last end is detected. When the last end is detected, the process proceeds to step S9. When the last end is not detected, the process returns to step S6.

In step S9, it is determined whether the operator requests the QR code addition. When the QR code addition is requested, the process proceeds to step S10. When the QR code addition is not requested, the process proceeds to step S14.

In step S10, the QR code creation is performed. In step S11, the QR code data one line reading is performed. In step S12, the QR code data one line writing is performed. In step S13, it is determined whether the last end is detected. When the last end is detected, the process proceeds to step S14. When the last end is not detected, the process returns to step S11. In step S14, the FAX coding is performed, thereby completing the image data processing.

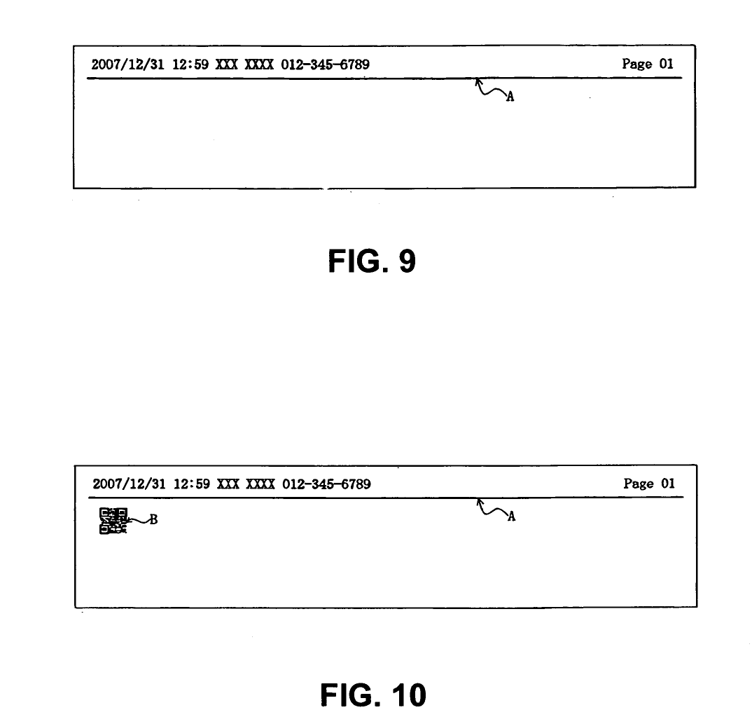

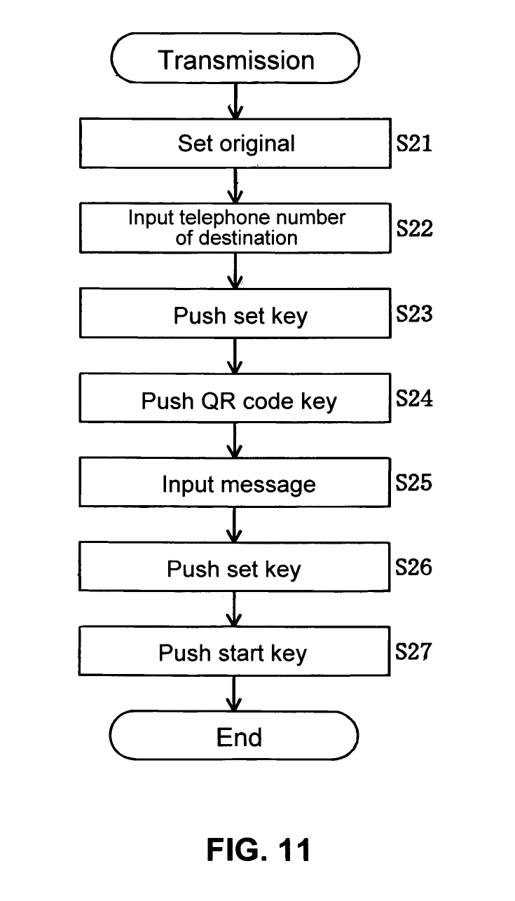

A transmission operation for transmitting the original will be explained next. FIG. 9 is a schematic view showing an example No. 1 of a transmitted image without the QR code according to the first embodiment of the present invention. FIG. 10 is a schematic view showing an example No. 2 of the transmitted image with the QR code according to the first embodiment of the present invention. FIG. 11 is a flow chart showing an operation of the communication device according to the first embodiment of the present invention.

First, the operator sets the original with the image to be transmitted, i.e., a transmission original, at a reading position of the reading unit 60. Then, the operator operates the operational panel 100 to input a telephone number of the destination. After inputting the telephone number of the destination, the operator pushes the set key of the operational panel 100.

In the next step, the operator pushes the QR code key of the operational panel 100, thereby starting inputting the message to be converted to the QR code. Then, the operator operates the operational panel 100 to input the message. After inputting the message, the operator pushes the set key of the operational panel 100.

In the next step, the operator pushes the start key of the operational panel 100, thereby completing the transmission operation for starting transmitting the image of the original. Accordingly, as shown in FIG. 10, it is possible to transmit the image containing the QR code at the front end thereof in addition to the origination information.

In the embodiment, as shown in FIG. 10, a portion A indicates the origination information, and a portion B indicates the QR code. When the operator does not push the QR code key of the operational panel 100, the image does contain the origination information at the front end thereof, and does not contain the QR code as shown in FIG. 9.

The flow chart shown in FIG. 11 will be explained next. In step S21, the transmission original is set at the reading position. In step S22, the telephone number of the destination is input. In step S23, the set key is pushed. In step S24, the QR code key is pushed. In step S25, the message is input. IN step S26, the set key is pushed. In step S27, the start key is pushed, thereby completing the transmission operation.

As described above, in the embodiment, it is possible to easily edit the QR code to be added to the transmitted image when the transmission operation is started, thereby making it possible to transmit a large amount of messages such as an address of a company, a commercial message of a company, and the likes. Accordingly, it is possible to significantly improve information transmission capability of the communication device.

Further, it is possible to register a specific commercial message and the likes in a message storage unit in advance.

### Second Embodiment

A second embodiment of the present invention will be explained next. Components in the second embodiment similar to those in the first embodiment are designated with the same reference numerals, and explanations thereof are omitted. The components similar to those in the first embodiment provide similar effects, and explanations thereof are omitted.

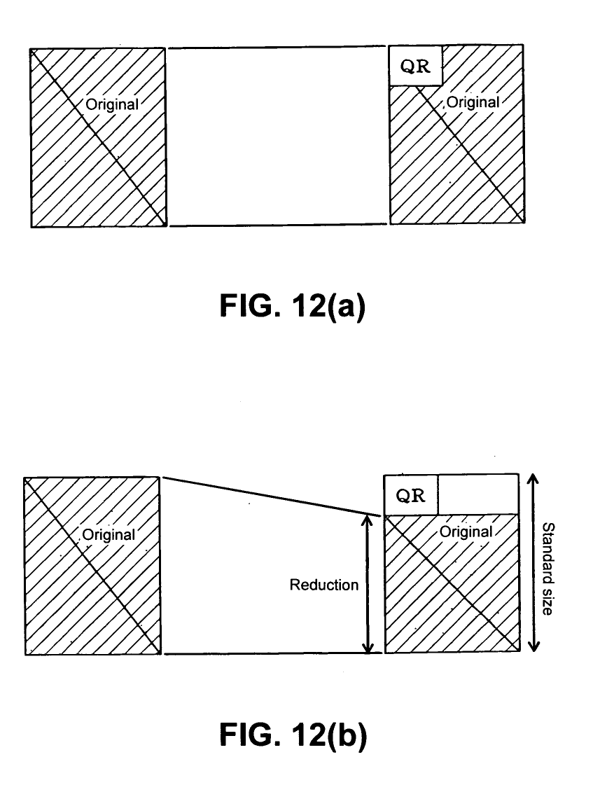

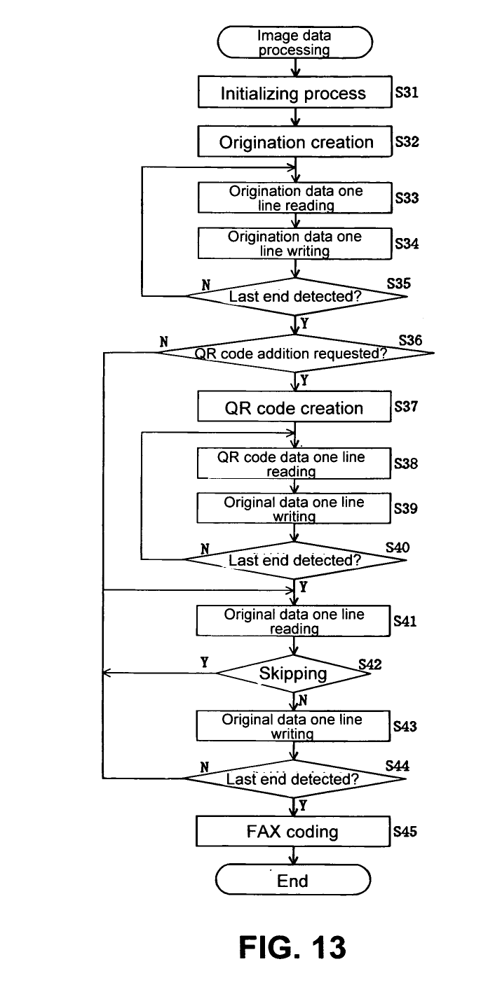

FIGS. 12(a) and 12(b) are schematic views showing transmitted images according to the second embodiment of the present invention. More specifically, FIG. 12(a) is a view showing the transmitted image without a skipping process, and FIG. 12(b) is a view showing the transmitted image with the skipping process. FIG. 13 is a flow chart showing an operation of the image data processing section 35 according to the second embodiment of the present invention.

An operation of an image data processing executed with the image data processing section 35 will be explained. In the embodiment, the reading control section 33 starts the image data processing section 35, so that the image data processing section 35 executes the image data processing while reading the original.

First, the image data processing section 35 executes an initializing process. Accordingly, the image data processing section 35 clears control data generated upon executing the image data processing.

In the next step, the image data processing section 35 executes the “origination creation” for creating the origination information. In the “origination creation”, the image data processing section 35 retrieves font data corresponding to the origination information from the data stored in the transmission date and time storage unit 45, the FAX number storage unit 44, and the transmitted page number storage unit 46. Then, the image data processing section 35 rasterizes and stores the dot image data in the origination creation data storage unit 49.

In the next step, the image data processing section 35 executes the “origination data one line reading”, that is, the image data processing section 35 retrieves the dot image data of one line from the origination creation data storage unit 49. As described above, the dot image data with the upper left of the origination information as the standard point are stored in the origination creation data storage unit 49. One line corresponds to data obtained through scanning the origination information from the left side to the right side. When the original having the A-4 size is scanned at the standard resolution (8 dots/mm), a total size of the data becomes 1728 bytes.

In the next step, the image data processing section 35 executes the “origination data one line writing”, that is, the image data processing section 35 writes the data of one line obtained through the “origination data one line reading” to the image data storage unit 51.

In the next step, the image data processing section 35 determines whether a last end is detected to determine a last end of the origination information. In detecting the last end, a byte number written in the origination creation data storage unit 49 is compared with a byte number read through the “origination data one line reading”.

When a comparison result is not matched, it is determined that the last end is not detected, and the “origination data one line reading” is performed one more time. When the comparison result is matched, it is determined that the last end is detected. Accordingly, the image data processing section 35 performs the QR request determination and determines whether the QR code is added with the QR code request flag 53. As described above, the QR code request flag 53 indicates whether the operator requests to add the QR code through the operation panel control section 32.

When the QR code request flag 53 is OFF, it is determined that the QR code is not added, and the image data processing section 35 executes the “original data one line reading”. When the QR code request flag 53 is ON, it is determined that the QR code is added, and the image data processing section 35 executes the “QR code creation” for creating the QR code. In creating the QR code, the image data processing section 35 rasterizes the data stored in the URL storage unit 42, the telephone number storage unit 43, and the message storage unit 47 according to ISO/IEC18004 standard, and stores the dot image data in the QR code creation data storage unit 50. At this time, the bit number of one line is temporarily stored in a temporary storage area.

In the next step, the image data processing section 35 executes the “QR code data one line reading”, so that the image data processing section 35 retrieves the dot image data of one line from the QR code creation data storage unit 50. As described above, the dot image data with the upper left of the QR code as the standard point are stored in the QR code creation data storage unit 50. One line corresponds to data obtained through scanning the QR code from the left side to the right side, and has a byte number corresponding to an information amount contained in the QR code. Then, the byte number of one line is retrieved from the temporarily storage area, thereby stopping retrieving.

In the next step, the image data processing section 35 executes the “QR code data one line writing”, so that the image data processing section 35 writes data of one line read through the “QR code data one line reading” into the image data storage unit 51. Accordingly, the data are written into the image data storage unit 51 after the origination information.

In the next step, the image data processing section 35 determines whether the last end is detected to determine the last end of the QR code. In detecting the last end, a number re-read to a bit number from the byte number of one line in the temporary storage area is compared with a number of reading in the “QR code data one line reading”. For example, when the byte number of one line is 10, the bit number is 80, and the number re-read becomes 80.

When a comparison result is not appropriate, that is, the number of reading in the “QR code data one line reading” is not a number capable of being converted to a number corresponding to a same length in the main scanning direction, it is determined that the last end is not detected, that is, the last end of the QR code is not detected. Accordingly, the “QR code data one line reading” is performed one more time.

When the comparison result is appropriate, that is, the number of reading in the “QR code data one line reading” is a number capable of being converted to a number corresponding to a same length in the main scanning direction, it is determined that the last end is detected, that is, the last end of the QR code is detected.

In the next step, the image data processing section 35 executes the “original data one line reading”, that is, the image data processing section 35 retrieves the dot image data of one line from the original read data storage unit 48. As described above, the dot image data with the upper left of the original as the standard point are stored in the original read data storage unit 48. One line corresponds to data obtained through scanning the original from the left side to the right side. When the original having the A-4 size is scanned at the standard resolution (8 dots/mm), a total size of the data becomes 1728 bytes.

In the next step, the image data processing section 35 executes skipping of the “original data one line reading”. In the skipping, the original data are not written at a specific interval, and data obtained through scanning the original from an upper side to a lower side, i.e., sub-scanning, are reduced. For example, when data are reduced to 90%, the “original data one line writing” is not performed one in every ten attempts.

With the skipping, the image of the original is reduced as shown in FIG. 12(b), so that the QR code is not overlapped with the image of the original. Accordingly, it is possible to prevent the image information of the original from being missing due to combining with the QR code.

On the other hand, without the skipping, the image of the original is not reduced as shown in FIG. 12(a), so that the QR code is overlapped with the image of the original. Accordingly, the image information of the original may be missing due to combining with the QR code.

In the embodiment, the interval of the skipping is determined through the following calculations.

A remaining line number accommodated in the standard size is obtained by subtracting a line number of the additional information from a total line number of a standard size. (A remaining line number accommodated in the standard size=a total line number of a standard size−a line number of the additional information)

A reduction ratio is obtained by dividing the remaining line number accommodated in the standard size by a line number of the image data. (A reduction ratio=the remaining line number accommodated in the standard size/a line number of the image data)

The interval of the skipping is obtained as an inverse number of (1−the reduction ratio). (The interval of the skipping=1/(1−the reduction ratio)

In the skipping, the “original data one line reading” is not performed according to the interval of the skipping obtained as described above.

In the next step, the image data processing section 35 executes the “original data one line writing”, that is, the image data processing section 35 writes the data of one line obtained through the “original data one line reading” to the image data storage unit 51.

In the next step, the image data processing section 35 determines whether the last end is detected to determine the last end of the original. In detecting the last end, a byte number written in the original read data storage unit 48 with the reading control section 33 is compared with a byte number read through the “original data one line reading”.

When a comparison result is not matched, it is determined that the last end is not detected, and the “original data one line reading” is performed one more time. When the comparison result is matched, it is determined that the last end is detected.

In the next step, the image data processing section 35 executes the “FAX coding”, thereby completing the image data processing. In the “FAX coding”, the image data processing section 35 codes into the FAX code according to the dot image data stored in the image data storage unit 51, and stores the FAX code into the FAX coding data storage unit 52. More specifically, the image data processing section 35 codes the dot image data stored in the image data storage unit 51 to the FAX code according to the ITU-T.4/T.6 standard, and stores that FAX code into the FAX coding data storage unit 52.

The flow chart shown in FIG. 11 will be explained next. In step S31, the initializing process is performed. In step S32, the origination creation is performed. In step S33, the original data one line reading is performed. In step S34, the original data one line writing is performed. In step S35, it is determined whether the last end is detected. When the last end is detected, the process proceeds to step S36. When the last end is not detected, the process returns to step S33.

In step S36, it is determined whether the operator requests the QR code addition. When the QR code addition is requested, the process proceeds to step S37. When the QR code addition is not requested, the process proceeds to step S41.

In step S37, the QR code creation is performed. In step S38, the QR code data one line reading is performed. In step S39, the QR code data one line writing is performed. In step S40, it is determined whether the last end is detected. When the last end is detected, the process proceeds to step S41. When the last end is not detected, the process returns to step S38.

In step S41, the original data one line reading is performed. In step S42, it is determined whether the skipping is performed. In step S43, the original data one line writing is performed. In step S44, it is determined whether the last end is detected. When the last end is detected, the process proceeds to step S45. When the last end is not detected, the process returns to step S41. In step S45, the FAX coding is performed, thereby completing the image data processing.

As described above, in the embodiment, only the image portion is reduced. Accordingly, it is possible to prevent the image information from missing due to the combination of the QR code.

Alternatively, a position of the image may be shifted without reducing the image, thereby making it possible to prevent the image information from missing. Further, a micro QR code having a reduced size may be used, thereby making it possible to prevent the image information from missing.

The disclosure of Japanese Patent Application No. 2007-158114, filed on Jun. 15, 2007, is incorporated in the application by reference.

While the invention has been explained with reference to the specific embodiments of the invention, the explanation is illustrative and the invention is limited only by the appended claims.

What is claimed is:

1. A communication device comprising:
an input unit for inputting first image data and additional information;
a multi-dimensional code creation unit for creating a multi-dimensional code according to the additional information;
a combination unit for combining the multi-dimensional code with the first image data to create second image data; and
a transmission unit for sending the second image data.

2. The communication device according to claim 1, wherein said input unit includes an operation panel so that the additional information is input manually.

3. The communication device according to claim 1, wherein said multi-dimensional code creation unit is adopted to create a two-dimensional code.

4. The communication device according to claim 1, wherein said multi-dimensional code creation unit is adopted to create a QR (Quick response) code.

5. The communication device according to claim 1, wherein said combination unit is adopted to reduce a size of the first image data according to a size of the multi-dimensional code.

6. The communication device according to claim 1, wherein said input unit is adopted to receive the additional information including URL (Uniform Resource Locator) data.

7. The communication device according to claim 1, wherein said multi-dimensional code creation unit is adopted to create dot image data formed of a multi-dimensional code according to the additional information.

8. The communication device according to claim 7, wherein said combination unit is adopted to combine the dot image data and dot image data of the first image data.

9. The communication device according to claim 1, wherein said input unit includes an original reading unit for reading original data as the first image data.

10. The communication device according to claim 1, further comprising a registration storage unit for storing the additional information in advance, said multi-dimensional code creation unit retrieving the additional information stored in the registration storage unit when the first image data is requested to send.

11. The communication device according to claim 1, wherein said combination unit is adopted to skip the first image data according to a size of the multi-dimensional code data.

12. The communication device according to claim 6, wherein said input unit is adopted to receive the additional information including a storage address of information related to the communication device as the URL data.
